(19) United States
(12) Patent Application Publication
(10) Pub. No.: US 2013/0272945 A1
(43) Pub. Date: Oct. 17, 2013

(54) Method for Producing Silicon Chloride from Silicon Sludge

(71) Applicant: Korea Institute of Geoscience and Mineral Resources, (US)

(72) Inventors: Hee Dong Jang, Daejeon (KR); Kyun Young Park, Ansan-si (KR); Tae Won Kang, Daejeon (KR); Heoy Kyung Park, Seosan-si (KR)

(73) Assignee: Korea Institute of Geoscience and Mineral Resources, Daejeon (KR)

(21) Appl. No.: 13/860,901

(22) Filed: Apr. 11, 2013

(30) Foreign Application Priority Data
Apr. 12, 2012 (KR) 10-2012-0037687

(51) Int. Cl. C01B 33/08

(52) U.S. Cl. CPC C01B 33/08
USPC 423/341

(57) ABSTRACT

Provided is a method for producing silicon chloride from silicon sludge by separating and recovering silicon carbide from waste silicon sludge generated during a semiconductor manufacturing process. With the method for producing silicon chloride from silicon sludge according to the present invention, oil components, iron, silicon that are contained in the silicon sludge may be removed, and silicon carbide may be selectively separated, thereby making it possible to produce high purity silicon chloride that may be used as a raw material for producing silica, silicon, or the like.

### CROSS-REFERENCE TO RELATED APPLICATIONS

This application claims priority under 35 U.S.C. §119 to Korean Patent Application No. 10-2012-0037687, filed on Apr. 12, 2012, in the Korean Intellectual Property Office, the disclosure of which is incorporated herein by reference in its entirety.

### TECHNICAL FIELD

The following disclosure relates to a method for producing silicon chloride from silicon sludge by separating and recovering silicon carbide from waste silicon sludge generated during a semiconductor manufacturing process.

### BACKGROUND

In a process of cutting a silicon ingot in order to manufacture a silicon wafer for a semiconductor and a solar cell, a wire saw has been generally used. Here, the wire has a diameter of 0.14 μm, and cutting sludge containing silicon carbide (SiC) having an average particle size of 20 μm has been used. In most of the domestic silicon wafer manufacturing processes, sludge containing a large amount of SiC, silicon particles, cutting oil, and the like, has been generated, and the sludge was entirely buried underground by a waste disposal company until a few years ago. However, processed sludge in which an abrasive material and the cutting oil are mixed with each other contributes to about 68.1% of the cost for a silicon wafer processing process. Therefore, a technology of separating/recovering SiC having an average particle size of 20 μm and the cutting oil that are contained in the silicon sludge to reuse them in a silicon wafer cutting process has been developed and has been used. However, even in the case in which reusable components are separated/recovered from the sludge generated as describe above to thereby be reused, it was known that an amount of waste sludge remaining as a final residue to be discharged has grown to about 21,000 tons per year, based on 2010, and in accordance with the rapid growth of a photovoltaic silicon wafer industry, generation of the waste sludge will also correspondingly increase.

Since the sludge generated at the time of manufacturing a silicon wafer is classified as a specified waste, the sludge may not be treated by simply burning nor be simply buried due to the cutting oil component contained in the sludge. However, in the case in which useful components contained in the sludge may be effectively separated/recovered, SiC may be used as a raw material of a ceramic such as a high temperature refractory, a silica composite, or the like, and silicon powder may be used as a synthetic material for high purity silicon compounds and be used to manufacture a poly-silicon at the time of ultra-high purification. In the silicon sludge, although slightly different according to companies, generally silicon, SiC, and an oil component used as the cutting oil are mixed. Therefore, in order to effectively separate these materials and make products, a liquid and a solid should be efficiently separated. In the silicon sludge, small amounts of additives and metal components may be contained as well as the cutting oil and the abrasive material. Particularly, in the case of oil components, which are liquid components, by-products having a low thermal stability may be easily generated in a separation and purification process. Therefore, in order to purify the oil component from the silicon sludge and utilize the solid component as the ceramic material, a heat treatment technology of efficiently removing the oil component such as ethylene glycol and a technology of controlling and separating trace components such as the additive and metal should be developed. In the silicon sludge from which the oil component and metal component are removed, silicon and silicon carbide particles remain, and in the case in which these two kinds of particles are efficiently separated, the silicon particles and the silicon carbide particles may be obtained. These particles may be used as raw materials of various materials such as silicon compounds, structural ceramics, and the like.

### RELATED ART DOCUMENT

### Non-Patent Document

### (Non-Patent Document 1) KIGAM Bulletin, Vol. 12, No. 1, pp. 57-62 (Nov. 21, 2007)

### SUMMARY

An embodiment of the present invention is directed to providing a method for producing silicon chloride from silicon sludge, and more particularly, a method for producing silicon chloride by separating and recovering silicon carbide from silicon, silicon carbide, and cutting oil and a small amount of iron that are contained in waste silicon sludge generated in a semiconductor manufacturing process to thereby be reused to produce silica and silicon.

In one general aspect, a method for producing silicon chloride from silicon sludge includes: (a) distilling silicon sludge generated in a semiconductor manufacturing process to remove oil components; (b) dispersing the distilled silicon sludge into distilled water to prepare a silicon sludge solution; (c) performing ultrasonic treatment on the silicon sludge solution; (d) performing centrifugation on the ultrasonic treated silicon sludge solution to separate phases; (e) recovering silicon carbide particles from the phase-separated silicon sludge solution; and (f) reacting the silicon carbide particles with chlorine gas.

Hereinafter, the present invention will be described in detail.

In step (a), the distillation of the silicon sludge may be performed at 100 to 300° C., and more particularly, it may be most preferable in view of removal of the oil component in addition to cutting oil in the silicon sludge that the distillation of the silicon sludge is performed at 150 to 200° C. When the distillation temperature is excessively low, a process time may be significantly increased, and when the distillation temperature is excessively high, oil may be partially decomposed to cause discoloration.

In the distilled silicon sludge, the remaining oil components may be washed and removed using a solvent, followed by drying, such that powders may be obtained. As the used solvent in this case, any organic solvent may be used as long as the organic solvent may wash the oil component, and more specifically, methanol, ethanol, hexane, dichloromethane, or the like, may be used, but the present invention is not limited thereto.

As a method for drying the silicon sludge, any drying method may be used as long as the method is generally used, and in order to decrease a process time, the silicon sludge may be dried in a dry oven at 80 to 100° C. for 2 to 3 hours.

In the distilled, washed, and dried silicon sludge powder, the oil component is removed, and silicon, silicon carbide, and a small amount of metal components are contained, which is dispersed in distilled water, such that a silicon sludge solution may be prepared in a colloidal state. Here, it may be preferable in view of efficiency in a next ultrasonic treatment step that a concentration of silicon sludge of the silicon sludge solution is 2 to 5 weight %.

In the colloidal silicon sludge solution, adhered silicon-silicon carbide may be separated from each other by ultrasonic treatment.

The ultrasonic treatment of the silicon sludge solution may be performed by directly or indirectly applying ultrasonic waves to the solution, and those skilled in the art may select and perform an ultrasonic treatment method among general ultrasonic treatment methods as needed.

It is preferable that the ultrasonic treatment of the silicon sludge solution is performed at an intensity of 100 to 500 W for 10 to 300 minutes because the adhered silicon-silicon carbide may be most efficiently separated from each other. In the case in which the intensity of the ultrasonic wave is excessively strong, a temperature of the silicon sludge solution is rapidly increased to evaporate the solution, such that it may be difficult to continue the ultrasonic treatment, and in the case in which the intensity of the ultrasonic wave is excessively weak, the adhered silicon-silicon carbide may not be separated. The ultrasonic treatment of the silicon sludge solution may be performed at a constant intensity of ultrasonic waves, or be performed while changing the intensity of the ultrasonic waves according to the times. When the ultrasonic treatment time is excessively short, the adhered silicon-silicon carbide may not be completely separated from each other, such that separation and recovery efficiency of silicon may be slightly decreased, and when the time is excessively long, the separation efficiency is not further improved and only energy consumption may be increased. Therefore, the ultrasonic treatment may be preferably at an intensity of 200 to 400 W for 20 to 240 minutes.

The present inventors discovered that in producing silicon chloride from silicon sludge, silicon and silicon carbide may be separated from each other through the ultrasonic treatment, and thus silicon and silicon carbide may be efficiently separated from each other without injecting a separate additive during a separating and recovering process, thereby completing the present invention.

In the colloidal silicon sludge solution in which silicon and silicon carbide are separated from each other by the ultrasonic treatment, the silicon particles and silicon carbide particles may be selectively separated and recovered through centrifugation.

Through the centrifugation, iron and silicon carbide particles that are relatively heavy settle at the bottom, and silicon particles that are relatively light are present in an upper layer.

The centrifugation may be performed at 300 to 700 rpm for 5 to 100 minutes. When a rate of the centrifugation is excessively slow or a centrifugation time is excessively short, phase-separation of the silicon sludge solution may not be properly performed, and when the rate of the centrifugation is excessively rapid or the centrifugation time is excessively long, most of silicon is precipitated, such that efficiency of selectively recovering silicon carbide may be decreased.

It is more preferable that the centrifugation is performed at 450 to 550 rpm for 5 to 75 minutes so that efficiency of selectively separating and recovering the silicon carbide particles from the silicon sludge solution may be improved.

According to the present invention, the oil component may be removed from the silicon sludge through the above mentioned distillation process, the adhered silicon-silicon carbide in the silicon sludge may be separated from each other through the ultrasonic treatment, and silicon carbide may be selectively separated and recovered from the silicon sludge through the centrifugation. In addition, according to the present invention, silicon carbide may be efficiently recovered without injection of an additive for precipitating a specific component or without a separate device such as a magnetic separator, or the like, for removing iron.

The silicon carbide particles selectively obtained by centrifugation are reacted with chlorine gas, such that silicon chloride may be produced.

The reaction of silicon carbide and the chlorine gas may be carried out at 500 to 2000° C. for 30 to 600 minutes. In order to increase a chlorination conversion rate of silicon in the silicon carbide, the reaction may be carried out at 800 to 1500° C. for 50 to 500 minutes.

In the present invention, when the silicon carbide is allowed to be reacted with the chlorine gas, the silicon carbide particles may be directly input to a reactor or be input to an alumina boat to be charged in the reactor. In this case, the wider the contact area between the silicon carbide particles and chlorine gas, the high the reaction efficiency.

At the time of reaction of the silicon carbide and the chlorine gas, an input amount of the chlorine gas may be selectively adjusted according to the object, and it may be preferable in view of preventing the chlorine gas from being excessively used and reaction efficiency that the chlorine gas is flowed at a flow rate of 10 to 50 ml/min. The chlorine gas may be used alone or be mixed with nitrogen gas to be used in order to stabilize the reaction. In the case in which the chlorine gas and the nitrogen gas are mixed to be used, the chlorine gas and the nitrogen gas may be mixed at a volume ratio of 1:5 to 1:9.

The silicon chloride produced by the reaction with the chlorine gas is present in a gas phase directly after the reaction, and the small amount of metal components contained together with the silicon carbide particles obtained after the centrifugation may be reacted with the chlorine gas to thereby be present as metal chlorides.

The method for producing silicon chloride according to the present invention may further include, after the reacting of the silicon carbide particles with chlorine gas, capturing the silicon chloride by filtering un-reacted silicon carbide particles and the metal chlorides, such that high purity silicon chloride may be obtained.

In the case in which the capturing is performed at a temperature less than 100, the silicon chloride may be present in a gas phase, and the un-reacted silicon carbide particles and the metal chlorides are present in a solid phase, such that the silicon chloride may be efficiently filtered from the mixture thereof. As a filter used to filter the silicon chloride, any filter may be selectively used by those skilled in the art, as needed, as long as it may filter silicon chloride gas. According to the embodiment of the present invention, it may be preferable in view of filtration efficiency of the silicon chloride gas that pores of the filter have a diameter of 1 to 10 μm.

In the gas filtered by the filter after the capturing, the silicon chloride gas produced according to the present invention and un-reacted chlorine gas may be mixed.

The method for producing silicon chloride according to the present invention may further include absorbing and removing the un-reacted chlorine gas in order to obtain the high purity silicon chloride.

The un-reacted chlorine gas may be removed by passing a mixed gas of the silicon chloride gas and the un-reacted chloride gas through an absorption part filled with caustic soda after the capturing.

The chlorine gas that does not participate in the reaction is absorbed by the caustic soda while passing through the absorption part filled with the caustic soda, and the silicon chloride gas produced according to the present invention passes through the caustic soda absorption part, thereby making it possible to obtain highly concentrated silicon chloride.

The silicon chloride present in a gas phase after the reaction and purification may be present in a gas phase at room temperature, such that the silicon chloride may be captured in the gas phase in a storage tank or be cooled to a temperature lower than room temperature to thereby be captured in a liquid phase.

According to the present invention, the oil component may be removed from the silicon sludge by the distillation process as described above, the adhered silicon-silicon carbide may be separated from each other by the ultrasonic treatment, the silicon may be selectively separated and removed from the silicon sludge by centrifugation, and the recovered silicon carbide may be reacted with the chlorine gas, thereby making it possible to produce the silicon chloride. In addition, the metal contained at a small amount and the metal chloride reacted with the chlorine gas may be filtered by performing the capturing process after the reaction with the chlorine gas, and a purity of the silicon chloride gas may be increased by further performing the absorbing and removing process of the un-reacted chlorine gas.

### BRIEF DESCRIPTION OF THE DRAWINGS

FIG. 1 is a scanning electronic microscopy (SEM) photograph of the separated and recovered silicon carbide powders after the silicon carbide separating and recovering process according to Example 1.

FIG. 2 is a schematic view of a reaction device of the silicon carbide and chlorine gas according to the present invention.

FIG. 3 is a transmission electron microscopy (TEM) photograph of silicon carbide particles in an alumina boat after production of silicon chloride is completed according to Example 1.

FIG. 4 is a graph showing chlorination conversion rates of silicon in silicon carbide according to Examples 1, 5, 6, and 7 and Comparative Examples 1 and 2.

### DETAILED DESCRIPTION OF EMBODIMENTS

Hereinafter, although the present invention will be described in detail by the Examples, they are provided only for understanding of configurations and effects of the present invention and not for limiting the scope of the present invention.

As devices used to ultrasonically treat a silicon sludge solution, a digital sonifier (S-450D, Branson Ultrasonic) having a maximum power of 400 W and an ultrasonic cleaning device (JAC-4020P, Kodo) having a maximum power of 500 W were used.

As a centrifugal separator, VS-5500N (Vision Science) was used.

In order to analyze crystalline forms, shapes, and sizes of the separated and recovered silicon particles, an X-ray diffractometer (XRD, RTP 300 RC, Rigaku) and a Scanning Electron Microscopy (SEM, JSM-6308LA, Jeol) were used, respectively.

### EXAMPLE 1

### Production Silicon Chloride from Silicon Sludge

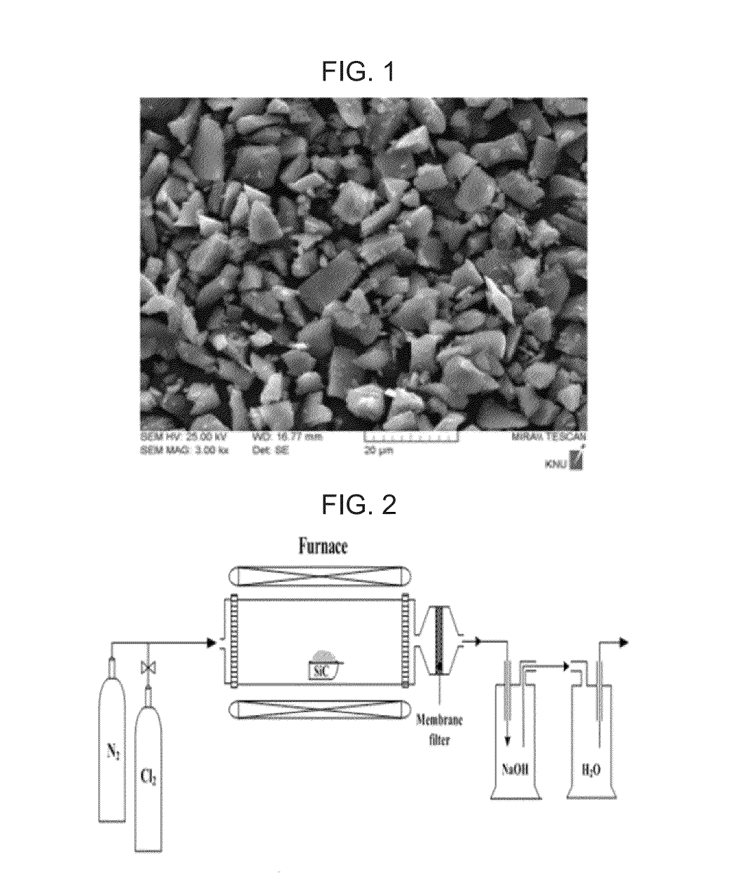

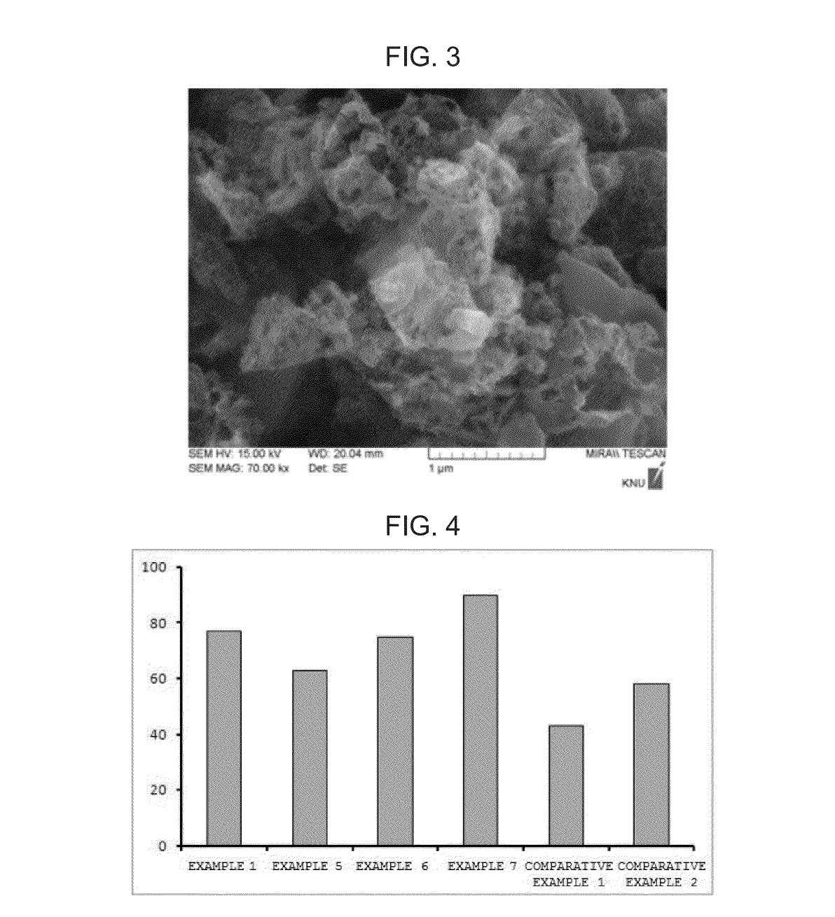

A flask charged with 200 g of waste silicon sludge generated in a semiconductor manufacturing process was heated for 2 hours while maintaining a temperature at 180° C. and distilled to remove oil components. The oil component removed sludge was washed with ethanol to remove the remaining oil component, followed by drying in a dry oven at 80° C. for 2 hours, such that powder was obtained. After 3 g of the dried powder was dispersed in 200 ml of distilled water to prepare silicon sludge solution, ultrasonic treatment was performed at an ultrasonic intensity of 320 W for 30 minutes by allowing an ultrasonic generator to directly contact the silicon sludge solution using the digital sonifier (S-450D, Branson Ultrasonic) having the maximum power of 400 W, and then phase separation of silicon sludge solution was performed at 500 rpm for 60 minutes using the centrifugal separator. After centrifugation, a lower layer solution of the silicon sludge solution was recovered and dried in a dry oven at 90° C., for 4 hours. Then, the obtained particles were analyzed using a SEM, and the SEM analysis of the particles morphology was shown in FIG. 1. A schematic view of a reaction device for reacting silicon carbide with chlorine gas to produce silicon chloride was shown in FIG. 2. After 1 g of obtained silicon carbide was filled in an alumina boat (size: 13×70×10 mm (WXDXH), volume: 5 ml) and then charged in a tubular reactor, a mixed gas in which chlorine gas and nitrogen gas were mixed at a volume ratio of 1:9 was flowed into the reactor at a flow rate of 300 ml/min for 1 hour while raising and maintaining a temperature in the reactor to 1100° C., thereby producing silicon tetrachloride (SiCl₄) gas. In order to filter and remove silicon carbide particles and metal chlorides that may be contained in the off-gas after reaction was completed, the gas was filtered through a circular filter (Whatman No. 2) having a diameter of 9 cm, thereby performing primary purification of the silicon chloride. The primary purification was performed while cooling the temperature to 80° C. Since the silicon tetrachloride (SiCl₄) gas produced through the reaction and un-reacted chlorine gas were contained in the gas passing through the filter, in order to absorb and remove the chlorine gas before capturing the silicon tetrachloride gas, the gas was allowed to pass through a cylinder shaped glass absorption device filled with 200 ml of caustic soda (1M), thereby producing and purifying the silicon tetrachloride (SiCl₄) gas. After the reaction was completed, the silicon carbide particles in the alumina boat were analyzed using a transmission electron microscopy (TEM) and the results were shown in FIG. 3, and the content of each of the components was analyzed using a scanning electron microscopy-energy dispersive spectrometry (SEM-EDS) and the results were shown in the following Table 1. As shown in FIGS. 1 and 3, it may be confirmed that pores were formed at positions at which Si was removed from the particles obtained after the reaction. The reason is that Si in the silicon carbide was converted into SiCl₄ gas by the reaction of the silicon carbide and the chlorine gas to thereby be discharged from the sample.

The chlorination conversion rate of silicon in the silicon carbide was confirmed through a weight ratio of an amount of silicon carbide input to the reaction and an amount of silicon carbide in the alumina boat after the reaction. The chlorination conversion rate of silicon in the silicon carbide was calculated by the following Equation 1 and the calculated results were shown in FIG. 4.

$$X = \frac{( {m}_{0} - m )}{0.7 {m}_{0}} \times 100 \qquad [ Equation 1 ]$$

In Equation 1, X indicates a conversion rate (%), m₀ indicates mass of silicon carbide input in a reaction tube, m indicates mass of silicon carbide in the alumina boat after the reaction, and 0.7m₀ as a denominator indicates mass of Si in a sample when it is assumed that the sample input to the reaction tube is pure SiC.

### EXAMPLE 2

### Production Silicon Chloride from Silicon Sludge

The same processes were performed as those in Example 1 except that the reaction of the silicon carbide and the chlorine gas was performed for 2 hours. After the reaction was completed, physical properties of the silicon carbide particles in the alumina boat were analyzed and the results were shown in the following Table 1.

### EXAMPLE 3

### Production Silicon Chloride from Silicon Sludge

The same processes were performed as those in Example 1 except that the reaction of the silicon carbide and the chlorine gas was performed for 4 hours. After the reaction was completed, physical properties of the silicon carbide particles in the alumina boat were analyzed and the results were shown in the following Table 1.

### EXAMPLE 4

### Production Silicon Chloride from Silicon Sludge

The same processes were performed as those in Example 1 except that the reaction of the silicon carbide and the chlorine gas was performed for 8 hours. After the reaction was completed, physical properties of the silicon carbide particles in the alumina boat were analyzed and the results were shown in the following Table 1.

### EXAMPLE 5

### Production Silicon Chloride from Silicon Sludge

The same processes were performed as those in Example 1 except that the reaction of the silicon carbide and the chlorine gas was performed at 1000° C. The chlorination conversion rate of silicon in the silicon carbide was confirmed and the result was shown in FIG. 4.

### EXAMPLE 6

### Production Silicon Chloride from Silicon Sludge

The same processes were performed as those in Example 1 except that the reaction of the silicon carbide and the chlorine gas was performed at 1200° C. The chlorination conversion rate of silicon in the silicon carbide was confirmed and the result was shown in FIG. 4.

### EXAMPLE 7

### Production Silicon Chloride from Silicon Sludge

The same processes were performed as those in Example 1 except that 1 g of silicon carbide was divided and filled in two alumina boats (size: 13'70×10 mm (WXDXH), volume: 5 ml) at an amount of 0.5 g per boat, and then charged in the tubular reactor. The chlorination conversion rate of silicon in the silicon carbide was confirmed and the results were shown in FIG. 4.

### COMPARATIVE EXAMPLE 1

### Production Silicon Chloride from Silicon Sludge

The same processes were performed as those in Example 1 except that the ultrasonic treatment of the silicon sludge solution was not performed, but only the distillation process and the centrifugation process were performed. The chlorination conversion rate of silicon in the silicon carbide was confirmed and the result was shown in FIG. 4.

### COMPARATIVE EXAMPLE 2

### Production Silicon Chloride from Silicon Sludge

The same processes were performed as those in Example 1 except for precipitating the silicon sludge solution at room temperature for 48 hours to recover the lower layer solution instead of phase separation of the silicon sludge solution using the centrifugal separator. The chlorination conversion rate of silicon in the silicon carbide was confirmed and the result was shown in FIG. 4.

### COMPARATIVE EXAMPLE 3

### Production Silicon Chloride from Silicon Sludge

The same processes were performed as those in Example 1 except that the gas after the reaction did not pass through a circular filter (Whatman, 2) having a diameter of 9 cm. After the reaction was completed, physical properties of the silicon carbide particles in the alumina boat were analyzed and the results were shown in the following Table 1.

TABLE 1

Component (%)

| Classification | C | Si | The rests | Sum |
|---|---|---|---|---|
| Example 1 | 69.02 | 17.36 | 13.62 | 100.0 |
| Example 2 | 65.57 | 7.55 | 26.88 | 100.0 |
| Example 3 | 83.43 | 2.54 | 14.03 | 100.0 |
| Example 4 | 83.33 | 1.43 | 15.24 | 100.0 |
| Comparative | 65.21 | 27.01 | 7.78 | 100.0 |
| Example 3 | | | | |

As shown in Table 1, it may be confirmed that with the method for producing silicon chloride from silicon sludge according to the present invention, high purity silicon chloride may be produced by a process of passing the gas after reaction through the filter to primarily purify the silicon chloride (SiCl₄).

With a method for producing silicon chloride from silicon sludge according to the present invention, oil components, iron, silicon that are contained in the silicon sludge may be removed, and silicon carbide may be selectively separated, thereby making it possible to produce high purity silicon chloride that may be used as a raw material for producing silica, silicon, or the like.

What is claimed is:

1. A method for producing silicon chloride from silicon sludge, the method comprising:
(a) distilling silicon sludge generated in a semiconductor manufacturing process to remove oil components;
(b) dispersing the distilled silicon sludge into distilled water to prepare a silicon sludge solution;
(c) performing ultrasonic treatment on the silicon sludge solution;
(d) performing centrifugation on the ultrasonic treated silicon sludge solution to separate phases;
(e) recovering silicon carbide particles from the phase-separated silicon sludge solution; and
(f) reacting the silicon carbide particles with chlorine gas.

2. The method of claim 1, wherein in step (a), the distillation of the silicon sludge is performed at 100 to 300° C.

3. The method of claim 1, wherein the silicon sludge solution in step (b) contains 2 to 5 weight % of silicon sludge.

4. The method of claim 1, wherein the ultrasonic treatment in step (c) is performed at an intensity of 100 to 500 W for 10 to 300 minutes.

5. The method of claim 1, wherein the centrifugation in step (d) is performed at 300 to 700 rpm for 5 to 100 minutes.

6. The method of claim 1, wherein the reaction of the silicon carbide particles and the chlorine gas in step (f) is performed at 500 to 2000° C. for 30 to 600 minutes.

7. The method of claim 2, wherein the distillation of the silicon sludge was performed at 150 to 200° C.

8. The method of claim 4, wherein the ultrasonic treatment is performed at an intensity of 200 to 400 W for 20 to 240 minutes.

9. The method of claim 5, wherein the centrifugation is performed at 450 to 550 rpm for 5 to 75 minutes.

10. The method of claim 6, wherein the reaction of the silicon carbide particles and the chlorine gas is performed at 800 to 1500° C. for 50 to 500 minutes.

11. The method of claim 1, further comprising, after the reaction in step (f), capturing silicon chloride by filtering un-reacted silicon carbide particles.

12. The method of claim 11, further comprising, after the capturing of the silicon chloride, absorbing and removing un-reacted chlorine gas.
